(19) United States
(12) Patent Application Publication
(10) Pub. No.: US 2014/0074924 A1
(43) Pub. Date: Mar. 13, 2014

(54) METHODS, APPARATUSES AND COMPUTER PROGRAM PRODUCTS FOR PROVIDING A MULTI-USER ENTERTAINMENT SYSTEM WITH CENTRALIZED PLAYLIST MANAGEMENT FOR NETWORKED MEDIA SOURCES

(71) Applicants: Ji-Dong Yim, Sunnyvale, CA (US); Juong-Sik Lee, San Jose, CA (US)

(72) Inventors: Ji-Dong Yim, Sunnyvale, CA (US); Juong-Sik Lee, San Jose, CA (US)

(73) Assignee: NOKIA CORPORATION, Espoo (FI)

(21) Appl. No.: 13/612,162

(22) Filed: Sep. 12, 2012

(51) Int. Cl. G06F 15/16

(52) U.S. Cl. 709/204

(57) ABSTRACT

An apparatus for multi-user media collaboration includes a processor and memory storing executable computer program code causing the apparatus to at least perform operations including generating a playlist including indications of media content responsive to requests from communication devices to include an item of media content in the playlist. The computer program code may further cause the apparatus to analyze an initial or subsequent item in the playlist to determine a communication device storing, or authorized to access, the item and to receive the item of media content from the communication device responsive to requesting the communication device to play the item. The computer program code may further cause the apparatus to provide data of the item being streamed to enable users of communication devices, that are physically co-located, to listen to audio or view visible data corresponding to the item. Corresponding methods and computer program products are also provided.

### TECHNOLOGICAL FIELD

An example embodiment of the invention relates generally to wireless communication technology and, more particularly, relates to a method, apparatus, and computer program product for multi-user collaboration of media content among communication devices in a communications network.

### BACKGROUND

The modern communications era has brought about a tremendous expansion of wireline and wireless networks. Computer networks, television networks, and telephony networks are experiencing an unprecedented technological expansion, fueled by consumer demand. Wireless and mobile networking technologies have addressed related consumer demands, while providing more flexibility and immediacy of information transfer.

Current and future networking technologies continue to facilitate ease of information transfer and convenience to users. Due to the now ubiquitous nature of electronic communication devices, people of all ages and education levels are utilizing electronic devices to communicate with other individuals or contacts, receive services and/or share information, media and other content. One area in which there is a demand to increase ease of information transfer relates to the delivery of services to a user of a mobile terminal. The services may be in the form of a particular media or communication application desired by a user(s), such as a music player, a game player, an electronic book, short messages, email, content sharing, etc. The services may also be in a collaborative entertainment system involving multiple users.

For instance, people who are situated in a group gathering for a limited time period, for example, in a vehicle, house party, cafe/pub, etc., often listen to or watch a channel of media together. A jukebox is an example system that helps a group of people load their preferred audio tracks in the machine and enjoy the music content in collaboration. Modern computing systems are capable of hosting such a jukebox (or a shared media player) service by playing digitally mastered entertainment content.

The major differences between the traditional and the existing digital systems may involve data storage, a monetization method, and an ownership policy of purchased content such as media content. In traditional systems, the media content may be stored in a local machine (e.g., a jukebox device) or in a subsystem of the machine (e.g., a vinyl record in the jukebox) and may be served in exchange for privacy-safe payment methods (e.g., coins). The purchased content may be performed at a place where the machine is located. The ownership to the content may expire once a performance is over (e.g., the user, or buyer pays per play). In current systems, the contents may be stored either in a local machine or in remote servers (e.g., the user's home computer, the user's cloud drive, the content provider's server, etc.), and payment may be digitally processed (e.g., through credit cards, user account information with an identifier (ID) and password, etc.). The purchased content may be performed anywhere anytime, as long as the user's entertainment device is connected to media storage and the user pays per content.

At present, a collaborative entertainment system involving multiple users and media sources may require a new media management structure and controlling protocols. In order to clarify the requirements of such an entertainment system, consider the following example.

Jane Doe (a fictitious person) is driving a car to Lake Tahoe. Three friends are in passenger seats of the car. The people in the car may be music lovers and have a lot of music files on their mobile devices. They may want to enjoy the audio of the music together in the car.

In the above example, Jane (the driver) and the passengers may want to play multiple songs one after another. In this regard, people in the car may desire to participate in a multi-user activity that enables each user to add/delete a song to/from a playlist and to change the order of the songs in the list. However, currently existing media player devices are typically designed for a single user. For example, presume that Jane and all other passengers share one music player device which contains a playlist. In order for the users to manage the list of songs to play together, the users may have to pass the device (or the controller interface) to each other. There are problems and drawbacks with this approach.

For instance, one drawback may involve a multi-user interface problem. In this regard, for example, sharing a device may prevent simultaneous operations to a playlist. As such, only one user may be able to view and access the playlist at a time. This may cause a user to forget the songs that the user had in mind while other users are holding the device.

Another drawback may involve privacy concerns (e.g., from a device owner's perspective). In other words, sharing a device may raise privacy concerns. Since music player functionalities are often a part of a personal communication device nowadays, the owner of the device may be concerned with usage of their device by other users that may browse the personal content in the device.

An additional drawback may involve copyright and privacy concerns (e.g., from a content owner's perspective). For example, a media player device may have restrictions in playing content sources that are distributed in devices or data storages of other users.

Currently, it is technologically possible for multiple users to share media content with each other in multiple devices. For instance, a user may share either the content source (e.g., the file) or the privilege to access the source (e.g., the file location and the ownership information to the data storage). Although it is technologically possible for multiple users to share media content, problems still remain. For example, duplicating a content source such as, for example, copying and pasting an Moving Picture Experts Group Layer-3 Audio (MP3) music file into the device of another user may violate Digital Right Management (DRM) policies.

Additionally, sharing ownership, for example, allowing others to know the file location of a content source, or using one's log-in ID and password through the device of another user may cause unintended access of stored personal data of another user and may cause potential threats of abusing personal data which potentially may be critical in terms of privacy, monetization, etc.

In view of the foregoing drawbacks, it may be desirable to provide a more efficient and reliable collaborative entertainment system enabling multiple users and media sources to share media content.

### SUMMARY

A method, apparatus and computer program product are therefore provided for providing a multi-user collaborative entertainment system that enables users to share media content in an efficient and reliable manner.

An example embodiment may provide an entertainment system that enables users in a network to build, to edit, and to play a shared playlist of media content during a time period while the users may be physically co-located together or agree to co-play the entertainment contents.

An example embodiment may facilitate multi-user activity in an entertainment system that may help users of communication devices by enabling each user to add/delete one or more items of media content to/from a playlist and to change the sequence of the order of the items of media content in the playlist.

In this regard, an example embodiment may enable provision of an entertainment system that connects multiple content sources including, but not limited to, communication devices (e.g., mobile terminals), media players, controller and/or viewer interface devices.

Additionally, an example embodiment may enable provision of a shared playlist. The playlist may enable users to select one or more items of media content by utilizing their communication devices (e.g., personal communication devices) and adding the selected content to the playlist. Multiple users may simultaneously view the status of the playlist (e.g., browse the shared playlist, read items of media content (e.g., track information), etc.) and may edit the playlist (e.g., change the order of the items of media content (e.g., music, videos, etc.), remove an item of media content (e.g., a track) from the playlist, etc.) from their communication devices.

Furthermore, an example embodiment may perform the playlist in a manner such that the items in the playlist run one-by-one as structured/specified by the users. Since the sources of content (e.g., files) may be owned (or purchased) by each individual user and may be distributed (or stored) in multiple devices, an example embodiment may facilitate playing of each item of media content by automatically reconnecting media streams for multiple media player devices. In other words, a host device may request each communication device to start/stop the content source at every change of an item of media content (e.g., a track (e.g., song) of an album). The actual play of an item of media content may be performed by each communication device. In an example embodiment, the decoded media stream may be transmitted to the host device. In an example embodiment, usage of file exchange protocols between devices may not necessarily be required since duplicating a source of content from a communication device to another communication device may cause copyright violations. In this regard, an example embodiment may minimize copyright violations.

Additionally, a host device of an example embodiment may not need to request any personal/privacy data (e.g., a user's log-in information, file location, etc.) to be transmitted from a media player device of a communication device to the host device. In this regard, an example embodiment may preserve privacy of a user(s). In an example embodiment, a host device may utilize the metadata of selected media content (e.g., title, author, running time, etc.) and a playlist index of an item(s) in order to run or play the items of media content in the playlist.

In one example embodiment, a method for providing multi-user collaboration of media content indicated in a shared playlist is provided. The method may include generating a shared playlist comprising indications of one or more items of media content in response to receipt of one or more requests from one or more communication devices to include a respective item of the items of media content in the shared playlist. The method may further include analyzing an initial or subsequent item, among the items, of the media content in the shared playlist to determine a first communication device that stores, or is authorized to access, the item of media content. The method may further include receiving a stream of the item of media content from the first communication device in response to sending a message to the first communication device requesting the first communication device to play the item of media content. The method may further include enabling provision of data of the item of media content being streamed to enable users of the communication devices, that are physically co-located together, to listen to audio data or view visible data corresponding to the item of media content.

In another example embodiment, an apparatus for providing multi-user collaboration of media content indicated in a shared playlist is provided. The apparatus may include a processor and a memory including computer program code. The memory and the computer program code are configured to, with the processor, cause the apparatus to at least perform operations including generating a shared playlist comprising indications of one or more items of media content in response to receipt of one or more requests from one or more communication devices to include a respective item of the items of media content in the shared playlist. The memory and the computer program code may further cause the apparatus to analyze an initial or subsequent item, among the items, of the media content in the shared playlist to determine a first communication device that stores, or is authorized to access, the item of media content. The memory and the computer program code may further cause the apparatus to receive a stream of the item of media content from the first communication device in response to sending a message to the first communication device requesting the first communication device to play the item of media content. The memory and the computer program code may further cause the apparatus to enable provision of data of the item of media content being streamed to enable users of the communication devices, that are physically co-located together, to listen to audio data or view visible data corresponding to the item of media content.

In another example embodiment, a computer program product for providing multi-user collaboration of media content indicated in a shared playlist is provided. The computer program product includes at least one computer-readable storage medium having computer-executable program code instructions stored therein. The computer-executable program code instructions may include program code instructions configured to generate a shared playlist comprising indications of one or more items of media content in response to receipt of one or more requests from one or more communication devices to include a respective item of the items of media content in the shared playlist. The program code instructions may also analyze an initial or subsequent item, among the items, of the media content in the shared playlist to determine a first communication device that stores, or is authorized to access, the item of media content. The program code instructions may also cause receipt of a stream of the item of media content from the first communication device in response to sending a message to the first communication device requesting the first communication device to play the item of media content. The program code instructions may also enable provision of data of the item of media content being streamed to enable users of the communication devices, that are physically co-located together, to listen to audio data or view visible data corresponding to the item of media content.

### BRIEF DESCRIPTION OF THE SEVERAL VIEWS OF THE DRAWINGS

Having thus described some example embodiments of the invention in general terms, reference will now be made to the accompanying drawings, which are not necessarily drawn to scale, and wherein:

FIG. 1 is a schematic block diagram of a system according to an example embodiment of the invention;

FIG. 2 is a schematic block diagram of an apparatus according to an example embodiment of the invention;

FIG. 3 is a schematic block diagram of a network device according to an example embodiment of the invention;

FIG. 4 is a schematic block diagram of a system according to an example embodiment of the invention;

FIG. 5 is a schematic block diagram of another system according to an example embodiment of the invention;

FIG. 6 is a schematic block diagram of yet another system according to an example embodiment of the invention;

FIG. 7 is a diagram of a signal flow for registering items to a playlist according to an example embodiment of the invention;

FIG. 8 is a diagram of a signal flow for performing a playlist according to an example embodiment of the invention; and

FIG. 9 illustrates a flowchart for providing multi-user collaboration of media content corresponding to a shared playlist according to an example embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

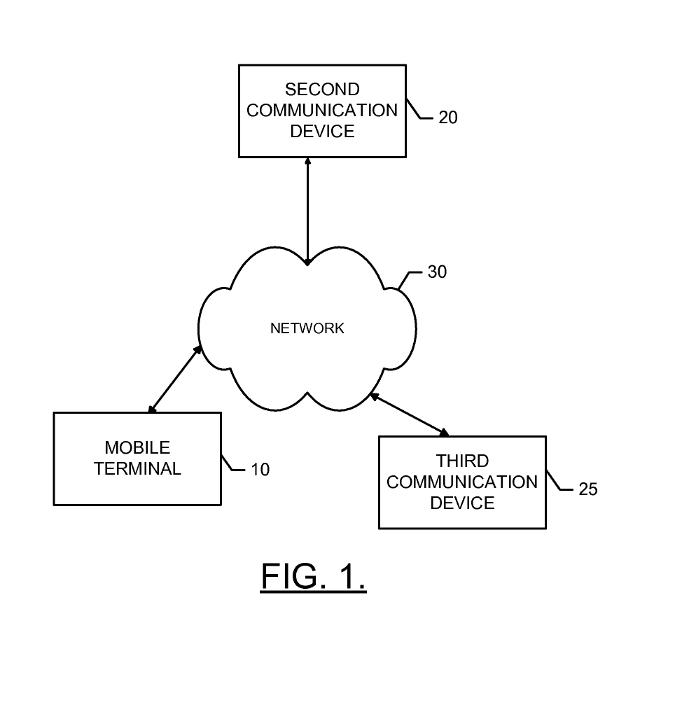

FIG. 1 illustrates a generic system diagram in which a device such as a mobile terminal 10 is shown in an example communication environment. As shown in FIG. 1, an embodiment of a system in accordance with an example embodiment of the invention may include a first communication device (e.g., mobile terminal 10) and a second communication device 20 capable of communication with each other via a network 30. In some cases, an embodiment of the invention may further include one or more additional communication devices, one of which is depicted in FIG. 1 as a third communication device 25. In one embodiment, not all systems that employ an embodiment of the invention may comprise all the devices illustrated and/or described herein. While an embodiment of the mobile terminal 10 and/or second and third communication devices 20 and 25 may be illustrated and hereinafter described for purposes of example, other types of terminals, such as portable digital assistants (PDAs), pagers, mobile televisions, mobile telephones, gaming devices, laptop computers, cameras, video recorders, audio/video players, radios, global positioning system (GPS) devices, Bluetooth headsets, Universal Serial Bus (USB) devices, electronic books (e-books), tablets (e.g., tablet computing devices) or any combination of the aforementioned, and other types of voice and text communications systems, can readily employ an embodiment of the present invention. Furthermore, devices that are not mobile, such as servers and personal computers may also readily employ an embodiment of the invention.

The network 30 may include a collection of various different nodes (of which the second and third communication devices 20 and 25 may be examples), devices or functions that may be in communication with each other via corresponding wired and/or wireless interfaces. As such, the illustration of FIG. 1 should be understood to be an example of a broad view of certain elements of the system and not an all-inclusive or detailed view of the system or the network 30. Although not necessary, in one embodiment, the network 30 may be capable of supporting communication in accordance with any one or more of a number of First-Generation (1G), Second-Generation (2G), 2.5G, Third-Generation (3G), 3.5G, 3.9G, Fourth-Generation (4G) mobile communication protocols, Long Term Evolution (LTE), LTE advanced (LTE-A) and/or the like. In one embodiment, the network 30 may be a point-to-point (P2P) network.

One or more communication terminals such as the mobile terminal 10 and the second and third communication devices 20 and 25 may be in communication with each other via the network 30 and each may include an antenna or antennas for transmitting signals to and for receiving signals from a base site, which could be, for example a base station that is a part of one or more cellular or mobile networks or an access point that may be coupled to a data network, such as a Local Area Network (LAN), a Metropolitan Area Network (MAN), and/or a Wide Area Network (WAN), such as the Internet. In turn, other devices such as processing elements (e.g., personal computers, server computers or the like) may be coupled to the mobile terminal 10 and the second and third communication devices 20 and 25 via the network 30. By directly or indirectly connecting the mobile terminal 10 and the second and third communication devices 20 and 25 (and/or other devices) to the network 30, the mobile terminal 10 and the second and third communication devices 20 and 25 may be enabled to communicate with the other devices or each other, for example, according to numerous communication protocols including Hypertext Transfer Protocol (HTTP) and/or the like, to thereby carry out various communication or other functions of the mobile terminal 10 and the second and third communication devices 20 and 25, respectively.

Furthermore, although not shown in FIG. 1, the mobile terminal 10 and the second and third communication devices 20 and 25 may communicate in accordance with, for example, radio frequency (RF), near field communication (NFC), Bluetooth (BT), Infrared (IR) or any of a number of different wireline or wireless communication techniques, including Local Area Network (LAN), Wireless LAN (WLAN), Worldwide Interoperability for Microwave Access (WiMAX), Wireless Fidelity (WiFi), Ultra-Wide Band (UWB), Wibree techniques and/or the like. As such, the mobile terminal 10 and the second and third communication devices 20 and 25 may be enabled to communicate with the network 30 and each other by any of numerous different access mechanisms. For example, mobile access mechanisms such as Wideband Code Division Multiple Access (W-CDMA), CDMA2000, Global System for Mobile communications (GSM), General Packet Radio Service (GPRS) and/or the like may be supported as well as wireless access mechanisms such as WLAN, WiMAX, and/or the like and fixed access mechanisms such as Digital Subscriber Line (DSL), cable modems, Ethernet and/or the like.

In an example embodiment, the first communication device (e.g., the mobile terminal 10) may be a mobile communication device such as, for example, a wireless telephone or other devices such as a personal digital assistant (PDA), mobile computing device, camera, video recorder, audio/video player, positioning device, game device, television device, radio device, or various other like devices or combinations thereof. The second communication device 20 and the third communication device 25 may be mobile or fixed communication devices. However, in one example, the second communication device 20 and the third communication device 25 may be servers, remote computers or terminals such as, for example, personal computers (PCs) or laptop computers.

In an example embodiment, the network 30 may be an ad hoc or distributed network arranged to be a smart space. Thus, devices may enter and/or leave the network 30 and the devices of the network 30 may be capable of adjusting operations based on the entrance and/or exit of other devices to account for the addition or subtraction of respective devices or nodes and their corresponding capabilities.

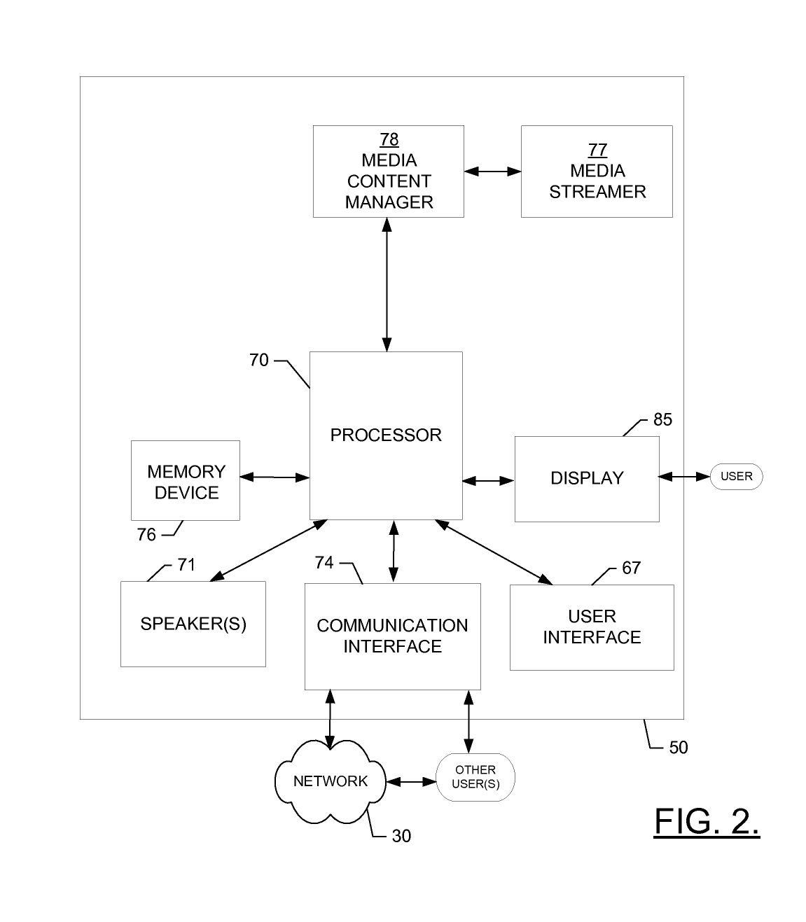

In an example embodiment, the mobile terminal 10 and the second and third communication devices 20 and 25 may employ an apparatus (e.g., apparatus of FIG. 2) capable of employing an embodiment of the invention.

FIG. 2 illustrates a schematic block diagram of an apparatus for sharing one or more items of media content of a playlist according to an example embodiment of the invention. An example embodiment of the invention will now be described with reference to FIG. 2, in which certain elements of an apparatus 50 are displayed. The apparatus 50 of FIG. 2 may be employed, for example, on the mobile terminal 10 (and/or the second communication device 20 or the third communication device 25). Alternatively, the apparatus 50 may be embodied on a network device of the network 30. However, the apparatus 50 may alternatively be embodied at a variety of other devices, both mobile and fixed (such as, for example, any of the devices listed above). In some cases, an embodiment may be employed on a combination of devices. Accordingly, one embodiment of the invention may be embodied wholly at a single device (e.g., the mobile terminal 10), by a plurality of devices in a distributed fashion (e.g., on one or a plurality of devices in a P2P network) or by devices in a client/server relationship. Furthermore, it should be noted that the devices or elements described below may not be mandatory and thus some may be omitted in a certain embodiment.

Referring now to FIG. 2, the apparatus 50 may include or otherwise be in communication with a processor 70, a user interface 67, one or more speakers 71 (also referred to herein as speaker(s) 71), a communication interface 74, a memory device 76, a display 85, a media streamer 77, and a media content manager 78 (also referred to herein as content manager 78). The memory device 76 may include, for example, volatile and/or non-volatile memory. For example, the memory device 76 may be an electronic storage device (e.g., a computer readable storage medium) comprising gates configured to store data (e.g., bits) that may be retrievable by a machine (e.g., a computing device like processor 70). In an example embodiment, the memory device 76 may be a tangible memory device that is not transitory. The memory device 76 may be configured to store information, data, files, applications, instructions or the like for enabling the apparatus to carry out various functions in accordance with an example embodiment of the invention. For example, the memory device 76 could be configured to buffer input data for processing by the processor 70. Additionally or alternatively, the memory device 76 could be configured to store instructions for execution by the processor 70. As yet another alternative, the memory device 76 may be one of a plurality of databases that store information and/or media content (e.g., audio data (e.g., music), pictures, videos (e.g., music), etc.).

The processor 70 may be embodied in a number of different ways. For example, the processor 70 may be embodied as one or more of various processing means such as a coprocessor, microprocessor, a controller, a digital signal processor (DSP), processing circuitry with or without an accompanying DSP, or various other processing devices including integrated circuits such as, for example, an ASIC (application specific integrated circuit), an FPGA (field programmable gate array), a microcontroller unit (MCU), a hardware accelerator, a special-purpose computer chip, or the like. In an example embodiment, the processor 70 may be configured to execute instructions stored in the memory device 76 or otherwise accessible to the processor 70. As such, whether configured by hardware or software methods, or by a combination thereof, the processor 70 may represent an entity (e.g., physically embodied in circuitry) capable of performing operations according to an embodiment of the invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and operations described herein when the instructions are executed. However, in some cases, the processor 70 may be a processor of a specific device (e.g., a mobile terminal or network device) adapted for employing an embodiment of the invention by further configuration of the processor 70 by instructions for performing the algorithms and operations described herein. The processor 70 may include, among other things, a clock, an arithmetic logic unit (ALU) and logic gates configured to support operation of the processor 70.

The processor 70 may be in communication with one or more speaker(s) 71. The speaker(s) may output audio data associated with one or more items of media content. The processor 70 may instruct the speaker(s) to play audio data in response to receipt of an indication from the media content manager 78 specifying that an item(s) of media content corresponding to the audio data is being played or executed.

In an example embodiment, the processor 70 may be configured to operate a connectivity program, such as a browser, Web browser or the like. In this regard, the connectivity program may enable the apparatus 50 to transmit and receive Web content such as, for example, location-based content or any other suitable content, according to a Wireless Application Protocol (WAP), for example. The processor 70 may also be in communication with a display 85 and may instruct the display to illustrate any suitable information, data, content (e.g., media content) or the like.

Meanwhile, the communication interface 74 may be any means such as a device or circuitry embodied in either hardware, a computer program product, or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network (e.g., network 30). In fixed environments, the communication interface 74 may alternatively or also support wired communication. As such, the communication interface 74 may include a communication modem and/or other hardware/software for supporting communication via cable, digital subscriber line (DSL), universal serial bus (USB), Ethernet or other mechanisms.

The user interface 67 may be in communication with the processor 70 to receive an indication of a user input at the user interface 67 and/or to provide an audible, visual, mechanical or other output to the user. As such, the user interface 67 may include, for example, a keyboard, a mouse, a joystick, a display, a touch screen, a microphone, a speaker, or other input/output mechanisms. In an example embodiment in which the apparatus is embodied as a server or some other network devices, the user interface 67 may be limited, remotely located, or eliminated. The processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the processor 70 may be embodied as, include or otherwise control the media content manager. The media content manager 78 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the media content manager 78 as described below. Thus, in an example in which software is employed, a device or circuitry (e.g., the processor 70 in one example) executing the software forms the structure associated with such means.

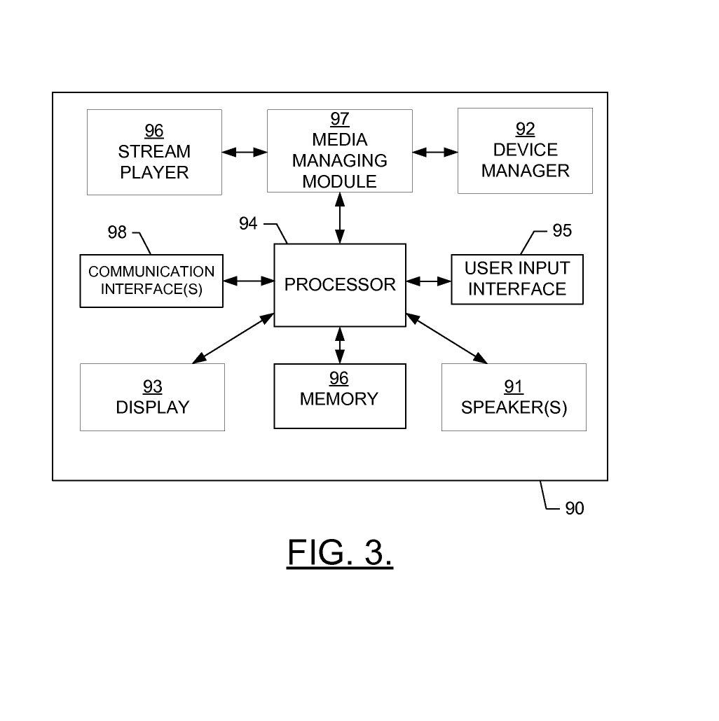

In an example embodiment, the media content manager 78 may enable playing of one or more items of media content (e.g., audio data, video data, images, etc.). The media content manager 78 may enable playing of one or more items of media content by instructing the media streamer 77 to play the item(s) of media content. The items of media content may be owned or purchased by a user of the apparatus 50. The media content manager 78 may receive an indication of a selection of an item(s) of media content to be included in or deleted from a playlist. The playlist may be maintained by network device (e.g., network device 90 of FIG. 3). The media content manager 78 may receive the indication from the user interface 67 in response to a user of the apparatus 50 selecting an item(s) of media content (e.g., from a file(s) in a memory (e.g., memory device 76)) and designating the item(s) of media content to be included in or deleted from the playlist.

In this regard, the media content manager 78 may send the network device a message requesting that the selected item(s) of media content be included in the playlist or removed from the playlist maintained by the network device. In this regard, the media content manager 78 may request the network device to register the selected item(s) of media content to the shared playlist. In an instance in which the network device performs the playlist, the network device may send a request or message to the media content manager 78 to run or execute the source of the item(s) of media content and transmit the live stream back to the network device. In this regard, the network device may play the item(s) of media content in the playlist, while the media content is being streamed from the media streamer 77 in response to receipt of one or more instructions from the media content manager 78 to stream the item(s) of media content. The network device may enable one more users of other apparatuses 50 to listen and/or view data associated with the selected item of media content being played from the playlist and output from the network device, as described more fully below.

In an example embodiment, the processor 70 may be embodied as, include or otherwise control the media streamer. The media streamer 77 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the media streamer 77 as described below. Thus, in an example in which software is employed, a device or circuitry (e.g., the processor 70 in one example) executing the software forms the structure associated with such means. In an example embodiment, the media streamer 77 may perform one or more media player tasks (e.g., play, pause, stop, rewind, fast forward, etc.). Additionally, the media streamer 77 may send decoded media stream data to a network device (e.g., network device 90 of FIG. 3), as described more fully below. The media stream data may correspond to an item(s) of media content identified in a playlist. The item(s) of media content may be stored in a memory (e.g., memory device 76) of the apparatus 50 or a remote device (e.g., a remote memory, a remote server, etc.)

Referring now to FIG. 3, a block diagram of a network device according to an example embodiment is provided. As shown in FIG. 3, the network device 90 (also referred to herein as host device 90) (e.g., a server) may include a processor 94, a memory 96, a user input interface 95, a communication interface(s) 98, a display 93, one or more speakers 91 (also referred to herein as speaker(s) 91), device manager 92, a stream player 96, and a media managing module 97 (also referred to herein as playlist manager 97). The memory 96 may comprise volatile and/or non-volatile memory, and may store content, data and/or the like. The memory 96 may store client applications, instructions, and/or the like for the processor 94 to perform the various operations of the network entity. The memory 96 may be a tangible non-transitory device. Additionally, the memory 96 may store one or more items of media content received from one or more apparatuses 50 and may store one or more playlists as well as any other suitable data.

The processor 94 may be embodied in a number of different ways. For instance, the processor 94 may be embodied as one or more of various processing means such as a coprocessor, microprocessor, a controller, a DSP, processing circuitry with or without an accompanying DSP, or various other processing devices including integrated circuits such as, for example, an ASIC, an FPGA, a MCU, a hardware accelerator, a special-purpose computer chip, or the like. In an example embodiment, the processor 94 may be configured to execute instructions stored in the memory 96 or otherwise accessible to the processor 94. As such, whether configured by hardware or software methods, or by a combination thereof, the processor 94 may represent an entity (e.g., physically embodied in circuitry) capable of performing operations according to an embodiment of the invention while configured accordingly. Thus, for example, when the processor 94 is embodied as an ASIC, FPGA or the like, the processor 94 may be specifically configured hardware for conducting the operations described herein. Alternatively, as another example, when the processor 94 is embodied as an executor of software instructions, the instructions may specifically configure the processor 94 to perform the algorithms and operations described herein when the instructions are executed. However, in some cases, the processor 94 may be a processor of a specific device (e.g., a mobile terminal or network device) adapted for employing an embodiment of the invention by further configuration of the processor 94 by instructions for performing the algorithms and operations described herein. The processor 94 may include, among other things, a clock, an arithmetic logic unit (ALU) and logic gates configured to support operation of the processor 94.

The processor 94 may also be connected to a communication interface 98 or other means for displaying, transmitting and/or receiving data, content, and/or the like. The user input interface 95 may comprise any of a number of devices allowing the network entity to receive data from a user, such as a keypad, a touch display, a joystick or other input device. In this regard, the processor 94 may comprise user interface circuitry configured to control at least some functions of one or more elements of the user input interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like).

The processor 94 may be in communication with a display 93. In an example embodiment the processor 94 may instruct the display 93 to show visible data (e.g., a playlist, video data (e.g., movies, video clips), an image(s), etc.) in response to receipt of a request or message from the media managing module 97. The media managing module 97 may send the processor 94 a request or message to instruct the display 93 to show visible data in response to the media managing module 97 playing or executing a corresponding item(s) of media content associated with the video data or an image(s).

Additionally, the processor 94 may be in communication with one or more speaker(s) 91. The processor 94 may instruct the speaker(s) 91 to output audio data (e.g., music (e.g., songs), audio associated with video data, etc.) in response to receipt of a request or message from the media managing module 97. The media managing module 97 may send the processor 94 a request or message to instruct the speaker(s) 91 to output audio data in response to the media managing module 97 playing or executing an item(s) of media content associated with the audio data.

In an example embodiment, the processor 94 may be embodied as, include or otherwise control the media managing module 97. The media managing module 97 may be any means such as a device or circuitry operating in accordance with software or otherwise embodied in hardware or a combination of hardware and software (e.g., processor 94 operating under software control, the processor 94 embodied as an ASIC or FPGA specifically configured to perform the operations described herein, or a combination thereof) thereby configuring the device or circuitry to perform the corresponding functions of the media managing module 97 as described below. Thus, in an example in which software is employed, a device or circuitry (e.g., the processor 94 in one example) executing the software forms the structure associated with such means.

The media managing module 97 may manage one or more playlists. The playlist(s) may be shared by one or more communication devices (e.g., apparatuses 50). The playlist(s) may include an ordered list or sequence of items of media content. The media managing module 97 may receive a request from one or more communication devices (e.g., apparatuses 50) to include or add a selected item(s) of media content to the playlist or to remove/delete an item(s) of media content from the playlist. The media managing module 97 may run or execute an item(s) of media content from the playlist in response to receipt of a transmission of a stream of the item(s) of media content from a corresponding communication device (e.g., an apparatus 50), as described more fully below.

In an example embodiment, the processor 94 may be embodied as, include or otherwise control the device manager 92. The device manager 92 may be any means such as a device or circuitry operating in accordance with software or otherwise embodied in hardware or a combination of hardware and software (e.g., processor 94 operating under software control, the processor 94 embodied as an ASIC or FPGA specifically configured to perform the operations described herein, or a combination thereof) thereby configuring the device or circuitry to perform the corresponding functions of the device manager 92 as described below. Thus, in an example in which software is employed, a device or circuitry (e.g., the processor 94 in one example) executing the software forms the structure associated with such means.

The device manager 92 may provide dynamic and automatic management of media streaming connections and disconnections for multiple communication devices (e.g., apparatuses 50). In this regard, the device manager 92 may set a media streaming connection with a communication device (e.g., apparatus 50) for a media item(s) corresponding to an item of media content identified in a playlist, as described more fully below.

In an example embodiment, the processor 94 may be embodied as, include or otherwise control the stream player 96. The stream player 96 may be any means such as a device or circuitry operating in accordance with software or otherwise embodied in hardware or a combination of hardware and software (e.g., processor 94 operating under software control, the processor 94 embodied as an ASIC or FPGA specifically configured to perform the operations described herein, or a combination thereof) thereby configuring the device or circuitry to perform the corresponding functions of the stream player 96 as described below. Thus, in an example in which software is employed, a device or circuitry (e.g., the processor 94 in one example) executing the software forms the structure associated with such means.

The stream player 96 may manage one or more streaming channels between the host device 90 and one or more communication devices (e.g., apparatuses 50), as described more fully below. The streaming channels may stream data received from one or more communication devices (e.g., apparatuses 50). The streamed data may correspond to an item(s) of media content identified in a playlist that may be managed by the media managing module 97.

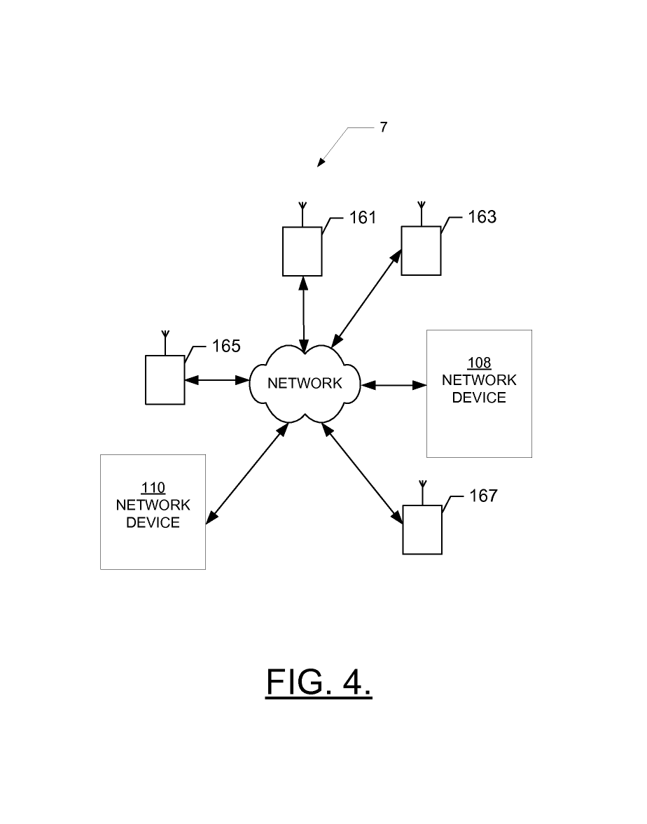

Referring now to FIG. 4, a diagram of a system according to an example embodiment is provided. The system 7 may include communication devices 161, 163, 165, 167 (e.g., apparatuses 50) and network devices 108 and 110 (e.g., network device 90). Although FIG. 4 shows that system 7 includes four communication devices 161, 163, 165, 167 and two network devices 108 and 110, it should be pointed out that system 7 may include any suitable number of communication devices 161, 163, 165, 167 and network devices 108, 110 without departing from the spirit and scope of the invention.

In the example embodiment of FIG. 4, the network device 108 (also referred to herein as host device 108) may manage one or more playlists. The playlists may include indications of one or more items of media content (e.g., audio (e.g., music (e.g., songs), videos (e.g., movies, video clips), images, etc.). The host device 108 may include the indications of the items of media content in a playlist in response to receipt of one or more messages from one or more of the communications devices 161, 163, 165 and/or 167 specifying inclusion of the media content in a playlist. Additionally, the host device 108 may remove or delete one or more items of media content from a playlist in response to receipt of one or more messages from one or more of the communication devices 161, 163, 165, and/or 167 requesting deletion of an item(s) of media content.

The items of media content indicated in a playlist may be stored in one or more of the communication devices 161, 163, 165 and/or 167. Additionally or alternatively, in one example embodiment, the one or more of the items of media content indicated in a playlist may be stored in network device 110 (e.g., a remote device (e.g., remote server)). In this regard, a corresponding communication device(s) may communicate with the network device 110 to receive an item(s) of media content stored in the network device 110. As such, the communication devices 161, 163, 165, 167 may access a corresponding item(s) of media content in a memory (e.g., memory device 76) of the communication devices 161, 163, 165, 167 or from network device 110 in response to receipt of a request from the host device 108. The request may indicate that the item(s) of media content (e.g., a song) is next in the ordered playlist to be played or run and may request a corresponding communication device (e.g., communication device 161) with access to the item(s) of media content to stream the item(s) of media content. In this regard, the host device 108 may receive the stream of the item(s) of media content and may provide the streamed data to one or more speakers (e.g., speaker(s) 91) and/or a display (e.g., display 93) such that users of the communication devices 161, 163, 165 and/or 167 may hear the data of the item(s) of media content (e.g., audio data (e.g., songs)) and/or view the data (e.g., video data) of the item(s) of media content.

In an example embodiment of FIG. 4, the communication devices 161, 163, 165, 167 as well as the users of the communications devices and the host device 108 may be physically co-located (e.g., together) in a same area or entity. For purposes of illustration and not of limitation, the communication devices 161, 163, 165, 167 as well as the users of the communication devices and host device 108 may, but need not, be physically co-located in an entity such as, for example, a vehicle, an office, a home or any other physically co-located area or entity. As such, the users of the communication devices 161, 163, 165, 167 may view (e.g., simultaneously view) the playlist managed by the host device 108 and may hear audio output from speakers (e.g., speakers(s) 91) of the host device 108, and/or visible data shown on a display (e.g., display 93) of the host device 108, corresponding to an item(s) of media content in the playlist.

In an alternative example embodiment, the communication devices 161, 163, 165, 167, the users of the communications devices and the host device 108 may not necessarily be physically co-located together. In this regard, the host device 108 may broadcast a streamed item of media content received from a corresponding communication device (e.g., communication device 161) to each of the communication devices 161, 163, 165, 167. In this manner, the host device 108 may provide audio data associated with the item(s) of media content to a speaker(s) (e.g., speaker(s) 71) of the communication devices and/or visible data corresponding to the item(s) of media content to a display (e.g., display 85) of the communication devices.

In the example of FIG. 4, the users of the communication devices may subscribe with the host device 108 to share a playlist among each other as a group. In addition, the host device 108 may manage playlists for other groups of users of communication devices.

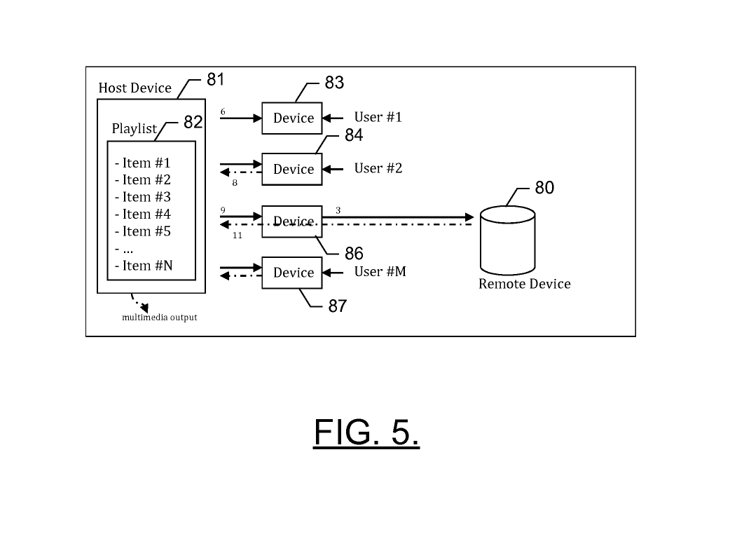

Referring now to FIG. 5, a diagram of a system according to an example embodiment is provided. The system of FIG. 5 may include a host device 81 (e.g., host device 108), devices 83, 84, 86, 87 (e.g., communication devices 161, 163, 165, 167) and a remote device 80 (e.g., network device 110). The host device 81 may store one or more playlists such as, for example, playlist 82. The playlist 82 may include indications of one or more items of media content. Although the system of FIG. 5 may include one host device 81, four devices 83, 84, 86, 87 and one remote device 80, the system of FIG. 5 may include any suitable number of host devices 81, devices 83, 84, 86, 87 and remote devices 80 without departing from the spirit and scope of the invention.

In the example embodiment of FIG. 5, the host device 81 may manage playlist 82 and may communicate with devices 83, 84, 86, 87 in which each of the devices may belong to a corresponding user. The playlist 82 may include an ordered list of items. Each item may be owned or purchased by a corresponding user. In an instance in which the host device 81 performs or executes the playlist 82, the host device 81 may send a request 6 to a device (e.g., device 83) to run or execute the source of the item(s) (e.g., Item #1) of media content. The request may be sent from the host device 81 to the device by utilizing an Audio/Video Remote Control Profile (AVRCP), a Digital Living Network Alliance (DLNA) or any compatible media control protocol. The request may instruct the device to transmit the live stream 8 back to the host device 81 (e.g., via an Advanced Audio Distribution Profile (A2DP), etc.).

In an instance in which user authentication may be needed to access the source of the item(s) of media content (e.g., the source of the item(s) of media content is stored in remote device 80 which requires log-in or payment records), the host device 81 may send a message 9 indicting to allow a device (e.g., device 86) to send a request 3 to the remote device 80 to run/execute the source of the item(s) of media content from the remote device 80, and to by-pass 11 the stream from the remote device 80 to the host device 81.

In the example embodiment of FIG. 5, one or more users of devices 83, 84, 86 and 87 may register content items to the playlist 82. For example, a user in the system of FIG. 5 may have a device (e.g., device 83) which is connected to the host device 81 and in this regard the user may utilize the device (e.g., device 83) to browse one or more media sources (e.g., file(s)) from the device (e.g., device 83) or from the remote device 80. In this manner, the device (e.g., device 83) may send a message or signal to the host device 81 to update (e.g., add or delete) one or more items in the playlist 82 based on information in the message. The information may include, but is not limited to, an identifier (ID) (e.g., a name, Bluetooth Media Access Control (MAC) address, etc.) of the device (e.g., device 83). Additionally, the information may, but need not, include metadata of the item(s) of media content (e.g., a title, author, duration of the item(s) of media content (e.g., a song, etc.) or any other suitable information) to be added or removed from the playlist 82. In an example embodiment, the information may not include user privacy data or direct information to content (e.g., a user's ID/password, credit card information, file location, Uniform resource locator (URL)/Uniform resource identifier (URI), etc.).

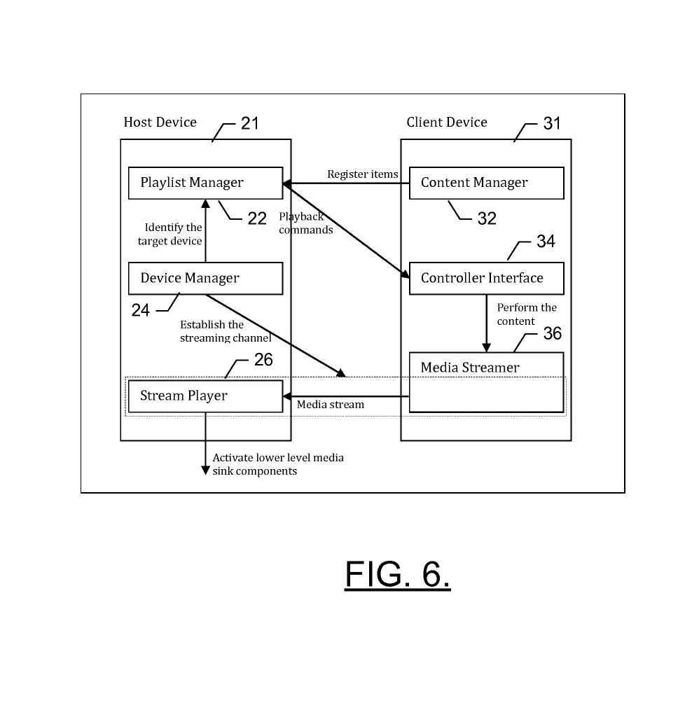

Referring now to FIG. 6, a diagram illustrating a host device and a client device of a system is provided according to an example embodiment. The host device 21 (e.g., host device 90) may include a playlist manager 22 (e.g., media managing module 97), a device manager 24 (e.g., device manager 92), and a stream player 26 (e.g., stream player 96). The client device 31 (e.g., apparatus 50) may include a content manager 32 (e.g., media content manager 78), a controller interface (e.g., processor 70), and a media streamer (e.g., media streamer 77).

The host device 21 may create one or more shared playlists in which each media item in the playlist(s) may be registered from a client device (e.g., client device 31). The host device 21 may manage the media streaming connections and disconnections for multiple client devices (e.g., devices 83, 84, 86, 87), and may pass the received media stream to an audio output channel for output via one or more speakers (e.g., speaker(s) 91) and/or a video output channel for display (e.g., via a display 93) of data associated with an item(s) of media content in a playlist (e.g., playlist 82).

The playlist manager 22 in the host device 21 may manage a shared playlist(s) (e.g., playlist 82) of items of media content that are registered from one or more client devices (e.g., client devices 31 (e.g., devices 83, 84, 86, 87)). The playlist manager 22, by request of a client device(s) (e.g., client device 31), may provide the client device(s) with detailed information about the current playlist and with the interface to edit the playlist. The playlist manager 22 may also determine the playing order of the registered items of media content included in the playlist and may send one or more playback commands (e.g., Play, Pause, Stop, Rewind, Fast Forward, etc.) to a client device(s) while performing or executing the playlist.

The device manager 24 in the host device 21 may provide dynamic and automatic management of media streaming connections and disconnections for multiple client devices (e.g., client devices 31 (e.g., devices 83, 84, 86, 87)). The device manager 24 may set or establish a media streaming connection with a target client device (e.g., client device 31) for an item(s) of media content according to information provided by the playlist manager 22. The information provided by the playlist manager 22 may include, but is not limited to, an indication of an identity of the target client device. The device manager 24 may also disconnect the media streaming connection in an instance in which playing of an item of media content in the playlist is completed.

The stream player 26 may manage the media streaming channels between the host device 21 and one or more client devices (e.g., client devices 31). The stream player 26 may receive the media stream, which may correspond to an item(s) of media content indicated in a playlist being played, from a client device (e.g., client device 31). In response to receipt of the media stream, the stream player 26 may send the media stream to one or more lower level media sink components such as, for example, a speaker(s) (e.g., speaker(s) 91), display (e.g., display 93), etc. In this regard, one or more users of client devices (e.g., client devices 31) may hear audio (e.g., music, etc.) associated with the item(s) of media content and/or visual data (e.g., a video clip, a movie(s), an image(s), etc.) shown on a display (e.g., display 93) of the host device 21.

The client device 31 may enable a user to browse/select one or more items of media content, in a playlist managed by the host device 21, from a local memory (e.g., memory device 76) and/or from a remote device (e.g., remote device 80). Additionally, the client device may request the host device 21 to register one or more items of media content to the shared playlist. The client device 31 may perform or execute (e.g., run, decode codecs, pause, stop, etc.) the item(s) of media content (e.g., a file) and may stream media from a source to the host device 21 which may the sink or provide the stream to one or more devices such as, for example, a speaker(s) (e.g., speaker(s) 91) and/or a display (e.g., display 93) of the host device 21.

The content manager 32 of the client device 31 may browse one or more media storage devices and may request the playlist manager 22 of the host device 21 to register the one or more selected items of media content to be included in a shared playlist (e.g., playlist 82). In this regard, the content manager 34 may provide Digital Rights Management since an item(s) of media content included in the playlist remains stored on the client device 31 or a memory of a remote device (e.g., remote device 80) that is accessible to the client device 31, but which is not provided to the host device 21.

The controller interface 34 may receive one or more playback commands (e.g., Play, Pause, Stop, Rewind, Fast Forward, etc.) from the playback manager 22 of the host device 21. The controller interface 34 may provide the commands to the media streamer 36 and may instruct the media streamer to execute one or more of the commands. The controller interface 34 may also handle callback signals (e.g., an indication of the end of an item(s) of media content (e.g., an end of a musical track, (e.g., song), etc.) and may report one or more events (e.g., the indication of the end of the item(s) of media content) to the host device 21.

The media streamer 36 may receive instructions from the controller interface 34 to perform or execute an item(s) of media content. In this regard, the media streamer 36 may execute one or more media player tasks (e.g., Play, Pause, Stop, Rewind, Fast Forward, etc.). The media streamer 36 may also decode a media stream corresponding to an item(s) of media content in a playlist (e.g., playlist 82). The media streamer 36 may send the decoded media stream to the stream player 26 of the host device 21 to enable the stream player 26 to provide audio data to one or more speakers (e.g., speakers(s) 91) and/or visual data to a display (e.g., display 93) corresponding to an item(s) of media data.

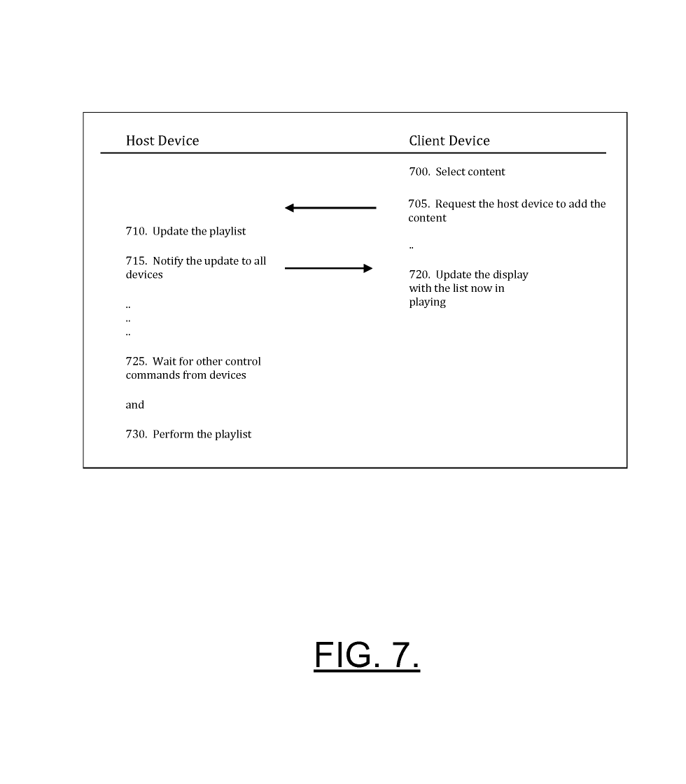

Referring now to FIG. 7, a signal flow diagram is provided for an example method of registering an item(s) of media content to a playlist. At operation 700, a client device (e.g., client device 31) may receive an indication of a selection of an item(s) of media content to be included in a playlist (e.g., playlist 82). In an example embodiment, the client device may detect the selection of the item(s) of media content in response to input by a user of the client device. At operation 705, the client device (e.g., client device 21) may generate a request that is sent to a host device (e.g., host device 21) requesting inclusion of the item(s) of media content in the playlist. At operation 710, the host device may update the playlist to include the selected item(s) of media content in response to receipt of the request from the client device.

At operation 715, the host device (e.g., host device 21) may notify the update of the playlist to one or more client devices (e.g., e.g., client devices 31 (e.g., devices 83, 84, 86, 87)). In one example embodiment, the host devices may send one or more notifications to the client devices informing the client devices that the playlist is updated. In an alternative example embodiment, the host device may notify the users of the client devices of the update to the playlist by providing the updated playlist to a display (e.g., display 93) to enable the users to view the updated playlist. At operation 720, the client device (e.g., client device 31) may provide the updated list being played to a display (e.g., display 85) in response to receiving the updated playlist from the host device.

At operation 725, the host device may wait for receipt of one or more other commands from client devices. In an example embodiment, the host device (e.g., host device 21) may wait for receipt of other commands from one or more other client devices for a predetermined time period. At operation 730, the host device may perform or execute the playlist. In an example embodiment, the host device may perform or execute the playlist upon expiration of the predetermined time period.

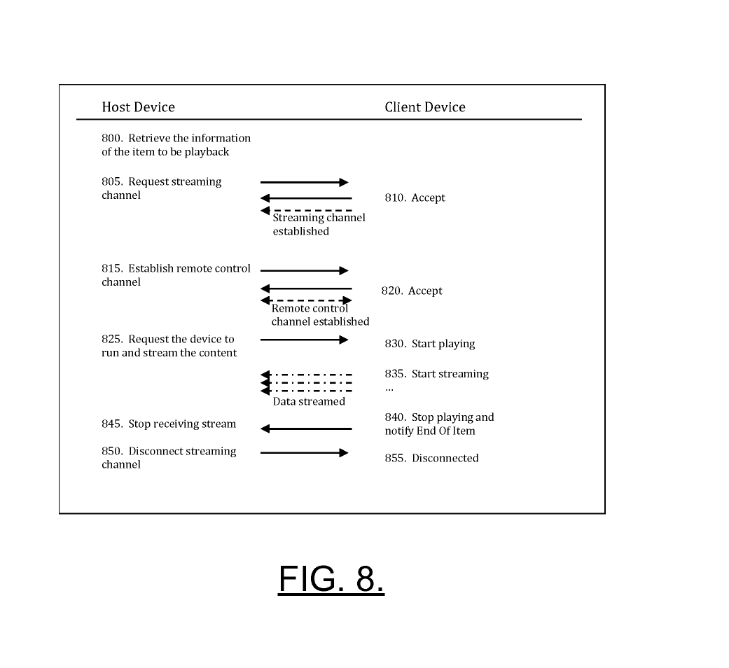

Referring now to FIG. 8, a signal flow diagram of an example method of playing an item of media content in a shared playlist according to an example embodiment is provided. At operation 800, the host device (e.g., host device 21) may detect an initial (e.g., Item #1) or next item (e.g., Item #2) to be performed from a shared playlist and may retrieve information indicating the item(s) of media content, to be play back, from the playlist (e.g., playlist 82). The retrieved information may also include an indication of a target client device (e.g., client device 31) that may store the item(s) of media content or has access to the item(s) of media content on a remote device (e.g., remote device 80). At operation 805, the host device (e.g., host device 21) may send a request to the client device requesting the client device to set up or establish a multimedia streaming channel between the host device and the client device for streaming one or more items of media content. In this regard, the streaming channel may be a channel dedicated to the transmission/reception of the items of media content indicated in a shared playlist.

At operation 810, the client device (e.g., client device 31) may send the host device (e.g., host device 21) a message indicating that the client device accepts the request to establish the multimedia streaming channel and indicating that the multimedia streaming channel is established. At operation 815, the host device (e.g., host device 21) may send a message to the client device (e.g., client device 31) that requests the client device to establish a remote control channel between the host device and the client device. At operation 820, the client device may send the host device a message indicating that client device accepts the request to establish the remote control channel and indicating that the remote control channel is established. In an example embodiment, the remote control channel may be a dedicated channel for transmission/reception control information including, but not limited to, instructions or commands to register an item(s) of media content to a shared playlist, update the data of the shared playlist, start or stop playing an item(s) of media content, pausing, rewinding, or fast forwarding an item(s) of media content, or any other suitable commands or instructions. At operation 825, the host device may send the client device a request (e.g., a play command) to run or execute the item(s) of media content indicated in the playlist and to stream the item(s) of media content (e.g., across the streaming channel). The host device may send the client device the request to run/execute the item(s) of media content via the remote control channel.

At operation 830, the client device may locate the source of the item(s) of media content from a local storage (e.g., memory device 76) or a remote device (e.g., remote device 80), resolves copyright and privilege issues and may start playing the item(s) of media content. At operation 835, the client device may start streaming the item(s) of media content, via the streaming channel, to the host device. At operation 840, the client device may detect that the end of the item(s) of media content is being played and once the playing of the item(s) of media content is complete, the client device may stop playing the item(s) of media content. In this regard, the client device may send a notification (e.g., an End of Item cue) to the host device indicating the end of the item(s) of media data and specifying that the playing of the item(s) of media content is complete. The client device may send the notification to the host device indicating the end of the item(s) of media data via the remote control channel. At operation 845, the host device may stop receiving streamed media from the client device. At operation 850, the host device may send a generated message instructing the client device to disconnect the streaming channel and the remote control channel. At operation 855, the client device may disconnect the streaming channel and the remote channel in response to receipt of the message. The host device and one or more client devices (e.g., devices 83, 84, 86, 87) may repeat operations 800-855 for a next item (e.g., Item #3) of media content indicted in the shared playlist (e.g., playlist 82).

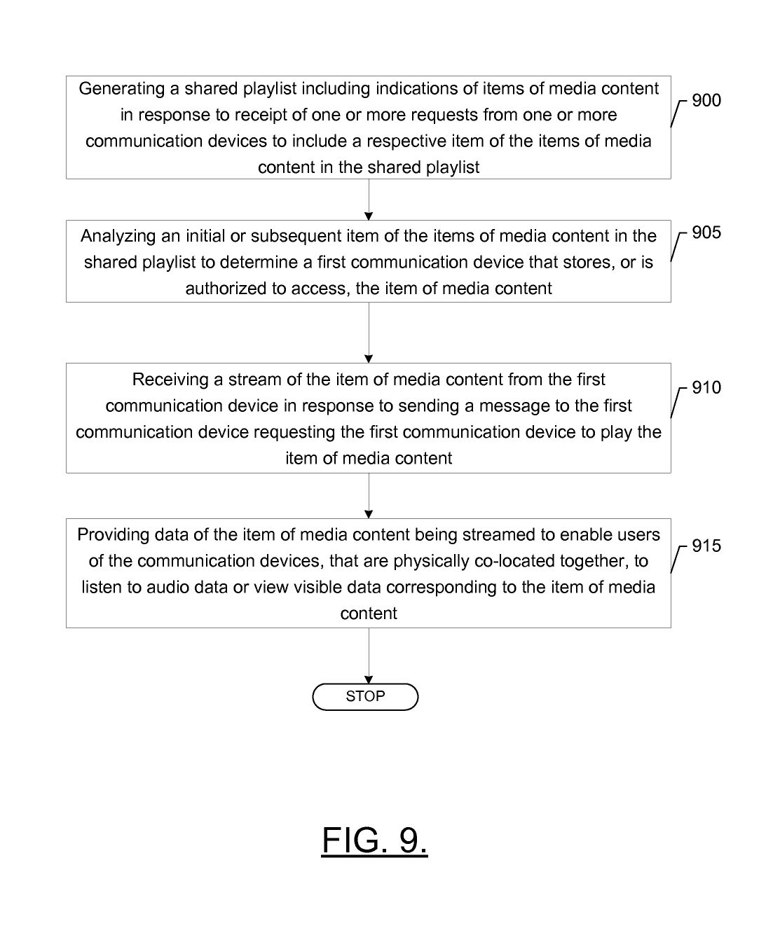

Referring now to FIG. 9, an example embodiment of a flowchart for providing multi-user collaboration of media content indicated in a shared playlist is provided. At operation 900, a host device (e.g., host device 90) may include means, such as the media managing module 97, the processor 94 and/or the like, for generating a shared playlist (e.g., playlist 82) including indications of one or more items of media content (e.g., Item #1, Item #2, etc.) in response to receipt of one or more requests from one or more communication devices (e.g., devices 83, 84, 86, 87) to include a respective item of the items of media content in the shared playlist. At operation 905, the host device (e.g., host device 90) may include means, such the media managing module 97, the processor 94 and/or the like for analyzing an initial (e.g., Item #1) or subsequent item (e.g., Item #2) of the media content in the shared playlist to determine a first communication device (e.g., device 83) that stores, or is authorized to access (e.g., from a remote device (e.g., remote device 80)), the item of media content.

At operation 910, the host device (e.g., host device 90) may include means, such as the device manager 92, the stream player 96, the processor 94 and/or the like for receiving a stream, via a streaming channel, of the item of media content from the first communication device (e.g., device 83) in response to sending a message to the first communication device requesting the first communication device to play the item of media content. At operation 915, the host device (e.g., host device 90) may include means, such as the stream player 96, the processor 94 and/or the like for providing data of the item of media content being streamed to enable users of the communication devices (e.g., devices 83, 84, 86, 87), that are physically co-located together, to listen to audio data or view visible data corresponding to the item of media content. In an example embodiment, the audio data may be output, by the stream player 96, to one or more speakers (e.g., speaker(s) 91) and/or the visible data may be provided to a display (e.g., display 93) for viewing by the users of the communication devices.

As described above, an example embodiment may avoid copyright violations and privacy concerns. For instance, consider an example in which a user purchased content in a device (e.g., device 83) and adds the content metadata (e.g., file location) into a shared playlist (e.g., playlist 82). A host device (e.g., host device 81) may perform the playlist and may schedule the sequence of items of media content to be played. However, the source of the content (e.g., an MP3 file) remains located in a device (e.g., device 83 or a remote device (e.g., remote device 80)) other than the host device (e.g., host device 81). Transferring the source of content from a device to a system and having the system run the content as a local resource as in conventionally existing approaches may cause a copyright violation. An example embodiment of the invention may avoid this copyright issue since the source of the content does not need to be provided to the host device.

It should be pointed out that FIGS. 7, 8 and 9 are flowcharts of a system, method and computer program product according to an example embodiment of the invention. It will be understood that each block of the flowcharts, and combinations of blocks in the flowcharts, can be implemented by various means, such as hardware, firmware, and/or a computer program product including one or more computer program instructions. For example, one or more of the procedures described above may be embodied by computer program instructions. In this regard, in an example embodiment, the computer program instructions which embody the procedures described above are stored by a memory device (e.g., memory device 76, memory 96) and executed by a processor (e.g., processor 70, processor 94). As will be appreciated, any such computer program instructions may be loaded onto a computer or other programmable apparatus (e.g., hardware) to produce a machine, such that the instructions which execute on the computer or other programmable apparatus cause the functions specified in the flowcharts blocks to be implemented. In one embodiment, the computer program instructions are stored in a computer-readable memory that can direct a computer or other programmable apparatus to function in a particular manner, such that the instructions stored in the computer-readable memory produce an article of manufacture including instructions which implement the function(s) specified in the flowcharts blocks. The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowcharts blocks.

Accordingly, blocks of the flowcharts support combinations of means for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In an example embodiment, an apparatus for performing the methods of FIGS. 7, 8 and 9 above may comprise a processor (e.g., the processor 70, processor 94) configured to perform some or each of the operations (700-730), (800-855) and (900-915) described above. The processor may, for example, be configured to perform the operations (700-730), (800-855) and (900-915) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (700-730), (800-855) and (900-915) may comprise, for example, the processor 70 (e.g., as means for performing any of the operations described above), the processor 94 and/or a device or circuit for executing instructions or executing an algorithm for processing information as described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
generating a shared playlist comprising indications of one or more items of media content in response to receipt of one or more requests from one or more communication devices to include a respective item of the items of media content in the shared playlist;
analyzing, via a processor, an initial or subsequent item, among the items, of the media content in the shared playlist to determine a first communication device that stores, or is authorized to access, the item of media content;
receiving a stream of the item of media content from the first communication device in response to sending a message to the first communication device requesting the first communication device to play the item of media content; and
enabling provision of data of the item of media content being streamed to enable users of the communication devices, that are physically co-located together, to listen to audio data or view visible data corresponding to the item of media content.

2. The method of claim 1, further comprising:
receiving an indication from the first communication device specifying that the playing of the item of media content is complete; and
enabling provision of a message to the first communication device to disconnect a streaming channel, in which the stream was received, in response to the received indication.

3. The method of claim 1, wherein enabling provision comprises at least one of outputting the audio data via one or more speakers or displaying the visible data.

4. The method of claim 1, wherein generating further comprises arranging the items of media content in an ordered sequence and the method further comprises:
scheduling playing of the items of media content based in part on the ordered sequence.

5. The method of claim 1, further comprising:
detecting a next item among the items of media content in the shared playlist to determine whether the first communication device, or another communication device, stores or is authorized to access, the next item of media content.

6. The method of claim 5, further comprising:
enabling provision of information of the next item of media content to enable the users of the communication devices to listen to other audio data or view other visible data corresponding to the next item of media content in response to receipt of a stream of the next item of media content from the another communication device.

7. The method of claim 1, further comprising:
deleting at least one of the items of media content from the shared playlist in response to receipt of a message from one of the communication devices requesting deletion of the at least one item from the shared playlist;
updating the shared playlist based in part on the deletion of the at least one item; and
enabling display of the updated shared playlist to facilitate viewing of the updated shared playlist by the users of the communication devices.

8. The method of claim 1, further comprising:
including another item of media content in the shared playlist in response to receipt of a request from one of the communication devices requesting inclusion of the another item of media content in the shared playlist;
updating the shared playlist based in part on the inclusion of the another item of media content; and
enabling display of the updated shared playlist to facilitate viewing of the updated shared playlist by the users of the communication devices.

9. The method of claim 1, wherein at least one of the items of media content comprises metadata identifying the at least one item of media content and specifying details related to the at least one item of media content, the method further comprises:
enabling display of the metadata in the visible data to enable the users to identify the at least one item of media content and the details of the at least one item of media content.

10. An apparatus comprising:
at least one processor; and
at least one memory including computer program code, the at least one memory and the computer program code configured to, with the at least one processor, cause the apparatus to perform at least the following:
generate a shared playlist comprising indications of one or more items of media content in response to receipt of one or more requests from one or more communication devices to include a respective item of the items of media content in the shared playlist;
analyze an initial or subsequent item, among the items, of the media content in the shared playlist to determine a first communication device that stores, or is authorized to access, the item of media content;
receive a stream of the item of media content from the first communication device in response to sending a message to the first communication device requesting the first communication device to play the item of media content; and
enable provision of data of the item of media content being streamed to enable users of the communication devices, that are physically co-located together, to listen to audio data or view visible data corresponding to the item of media content.

11. The apparatus of claim 10, wherein the at least one memory and the computer program code are further configured to, with the processor, cause the apparatus to:
receive an indication from the first communication device specifying that the playing of the item of media content is complete; and
enable provision of a message to the first communication device to disconnect a streaming channel, in which the stream was received, in response to the received indication.

12. The apparatus of claim 10, wherein the at least one memory and the computer program code are further configured to, with the processor, cause the apparatus to:
enable the provision by at least one of outputting the audio data via one or more speakers or displaying the visible data.

13. The apparatus of claim 10, wherein the at least one memory and the computer program code are further configured to, with the processor, cause the apparatus to:
generate the shared playlist by arranging the items of media content in an ordered sequence; and
schedule playing of the items of media content based in part on the ordered sequence.

14. The apparatus of claim 10, wherein the at least one memory and the computer program code are further configured to, with the processor, cause the apparatus to:
detect a next item among the items of media content in the shared playlist to determine whether the first communication device, or another communication device, stores or is authorized to access, the next item of media content.

15. The apparatus of claim 14, wherein the at least one memory and the computer program code are further configured to, with the processor, cause the apparatus to:
enable provision of information of the next item of media content to enable the users of the communication devices to listen to other audio data or view other visible data corresponding to the next item of media content in response to receipt of a stream of the next item of media content from the another communication device.

16. The apparatus of claim 10, wherein the at least one memory and the computer program code are further configured to, with the processor, cause the apparatus to:
delete at least one of the items of media content from the shared playlist in response to receipt of a message from one of the communication devices requesting deletion of the at least one item from the shared playlist;
update the shared playlist based in part on the deletion of the at least one item; and
enable display of the updated shared playlist to facilitate viewing of the updated shared playlist by the users of the communication devices.

17. The apparatus of claim 10, wherein the at least one memory and the computer program code are further configured to, with the processor, cause the apparatus to:
include another item of media content in the shared playlist in response to receipt of a request from one of the communication devices requesting inclusion of the another item of media content in the shared playlist;
update the shared playlist based in part on the inclusion of the another item of media content; and
enable display of the updated shared playlist to facilitate viewing of the updated shared playlist by the users of the communication devices.

18. The apparatus of claim 10, wherein at least one of the items of media content comprises metadata identifying the at least one item of media content and specifying details related to the at least one item of media content, the at least one memory and the computer program code are further configured to, with the processor, cause the apparatus to:
enable display of the metadata in the visible data to enable the users to identify the at least one item of media content and the details of the at least one item of media content.

19. A computer program product comprising at least one non-transitory computer-readable storage medium having computer-executable program code instructions stored therein, the computer-executable program code instructions comprising:
program code instructions configured to generate a shared playlist comprising indications of one or more items of media content in response to receipt of one or more requests from one or more communication devices to include a respective item of the items of media content in the shared playlist;
program code instructions configured to analyze an initial or subsequent item, among the items, of the media content in the shared playlist to determine a first communication device that stores, or is authorized to access, the item of media content;
program code instructions configured to cause receipt of a stream of the item of media content from the first communication device in response to sending a message to the first communication device requesting the first communication device to play the item of media content; and
program code instructions configured to enable provision of data of the item of media content being streamed to enable users of the communication devices, that are physically co-located together, to listen to audio data or view visible data corresponding to the item of media content.

20. The computer program product of claim 19, further comprising:
program code instructions configured to cause receipt of an indication from the first communication device specifying that the playing of the item of media content is complete; and
program code instructions configured to enable provision of a message to the first communication device to disconnect a streaming channel, in which the stream was received, in response to the received indication.
